(19) United States
(12) Patent Application Publication
(10) Pub. No.: US 2015/0222686 A1
(43) Pub. Date: Aug. 6, 2015

(54) SYSTEM AND A METHOD FOR SHARING INTERACTIVE MEDIA CONTENT BY AT LEAST ONE USER WITH AT LEAST ONE RECIPIENT OVER A COMMUNICATION NETWORK

(71) Applicant: Elijah Aizenstat, Santa Barbara, CA (US)

(72) Inventor: Elijah Aizenstat, Santa Barbara, CA (US)

(73) Assignee: Elijah Aizenstat, Santa Barbara, CA (US)

(21) Appl. No.: 14/281,930

(22) Filed: May 20, 2014

Related U.S. Application Data
(60) Provisional application No. 61/936,353, filed on Feb. 6, 2014.

(51) Int. Cl. H04L 29/06; G06F 3/16

(52) U.S. Cl. CPC H04L 65/602; G06F 3/165

(57) ABSTRACT

Disclosed is a system and a method for sharing interactive media content in between a user and at least one recipient over a communication network. The system comprises an audio search module, a customize module, a personalize module and a sharing module. The audio search module selects at least one audio media content. The customize module performs one or more editing operations on the selected audio media content for generating an edited audio media content. The personalize module merges the edited audio media content with interactive media content for generating a modified interactive media content. The sharing module enables at least one user to share modified interactive media content with at least one said recipient over the communication network.

### CROSS REFERENCE RELATED TO APPLICATION

This application claims priority to a U.S. Provisional Application No. 61/936,353 filed on Feb. 6, 2014, the entire content of which is incorporated herein by references in its entirety.

### BACKGROUND OF THE INVENTION

1. Field of the Invention

The present invention generally relates to a method and a system for interactive media sharing over a communication network, and more particularly relates to a method and a system for sharing modified interactive media file customized with meta-data over a communication network.

2. Description of Related Art

Several media items are commonly shared on the internet these days through social media websites. Examples of such media items include text, video, images, video clips etc. In addition to this, many media sharing applications have also been introduced on internet such as like Picasa, ProShow, iPhoto etc. These allow their users to navigate and store the data in an organized way along with the meta-data to be added at the time when the data is uploaded.

These applications and websites are extremely good at dispersing the data to huge audience but they lack the functionality of enabling their users to share it with other particular users. Keeping in view the changing scenario, the demand for sharing the data with a particular user instead of sharing it with a mass audience has not been met. Media sharing applications such as whatsapp, snapchat, wickr etc are providing some solutions to the existing demands of users for sending live media messages and then sharing that media with another user.

The popularity of music and photos sharing is well known to everybody in this industry. None of the existing applications provide a platform where music is shared together with features like cropping, adding of meta-data, and other requirements of the users. Therefore, there is a need of a method and a system for sharing modified media content customized with meta-data over a communication network. Further, the method should allow anonymous sharing of messages. Further, the method and the system should allow downloading of the media files from the communication network.

### SUMMARY OF THE INVENTION

In accordance with the teachings of the present invention, a method and a system for sharing interactive media content by at least one user with at least one recipient over a communication network is provided.

An object of the present invention is to provide a system for sharing modified interactive media content includes at least one database for storing one or more instructions related to at least one interactive media content and at least one processing unit coupled with at least one of the database. The processing unit is configured to execute one or more instructions stored in at least one of the database. The processing unit includes an audio search module, a customize module, a personalize module and a sharing module.

The audio search module selects at least one audio media content from at least one of the database, and the customized module performs one or more editing operations on the selected audio media content for generating an edited audio media content. Then the personalize module merges the edited audio media content with the pre-stored interactive media content for generating a modified interactive media content. Then, the sharing module enables the user to share the modified interactive media content with at least one of the recipient over the communication network.

Another object of the present invention is to provide a first crop module within the customize module to select a portion of the selected audio media content for creating a semi-edited audio media content. Further, the customize module includes a second crop module to select a portion of the semi-edited audio media content for creating the edited audio media content.

Another object of the present invention is to provide a text module within the personalize module to add textual messages to the edited audio media content for generating a modified audio media content. Further, the personalize module includes a visual media creation module to create a visual media content for merging with the edited audio media content for generating the modified audio media content.

The visual media content allows a user either to capture a live image or live video from a camera and then merging the created visual media content with the edited audio media content for generating modified interactive media content. Further, the visual media content allows a user to create visual media content by allowing the user to research through gallery of the database and uploading the pre-stored interactive media content for merging with the edited audio media content for creating the modified interactive media content.

Another object of the present invention is to provide a sharing module with an anonymous module for allowing the user to be anonymous before sharing the modified interactive media content with at least one recipient. Thus, the recipient is not aware about the user/sender. Further, the sharing module includes a first self-destruct module and a second self-destruct module for defining the number of times and number of views for automatically destructing the shared modified interactive media content from at least one of the database.

Another object of the present invention is to provide a system with a player module to play either of the edited audio media content, the visual media content or the modified interactive media content.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 illustrates a block diagram of a system for sharing interactive media content by at least one user with at least one recipient over a communication network in accordance with a preferred embodiment of the present invention;

FIG. 2 illustrates a flowchart of a method for sharing interactive media content by a user with at least one recipient over a communication network in accordance with another preferred embodiment of the present invention;

FIG. 3 illustrates a screenshot showing, by way of an example, a UI for registering a user on the database in accordance with an embodiment of the present invention;

FIG. 4A illustrates a screenshot showing, by way of an example, a UI for showing audio search module in accordance with an embodiment of the present invention;

FIG. 4B illustrates a screenshot showing, by way of an example, a UI for showing various databases in accordance with an embodiment of the present invention;

FIG. 5 illustrates a screenshot showing, by way of an example, a UI of customize module for performing one or more editing operations on the selected audio media content in accordance with an embodiment of the present invention;

FIG. 6 illustrates a screenshot showing, by way of an example, UI of merging module for merging edited audio media content with the pre-stored interactive media content in a preferred embodiment of the present invention;

FIG. 7A illustrates a screenshot showing, by way of an example, UI of sharing module for sharing modified interactive media content in a preferred embodiment of the present invention;

FIG. 7B illustrates a screenshot showing, by way of another example, UI of sharing module for sharing modified interactive media content in another preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE DRAWINGS

While this technology is illustrated and described in a preferred embodiment, a system and a method for sharing interactive media content by at least one user with at least one recipient over a communication network may be produced in many different configurations, forms and computer languages. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

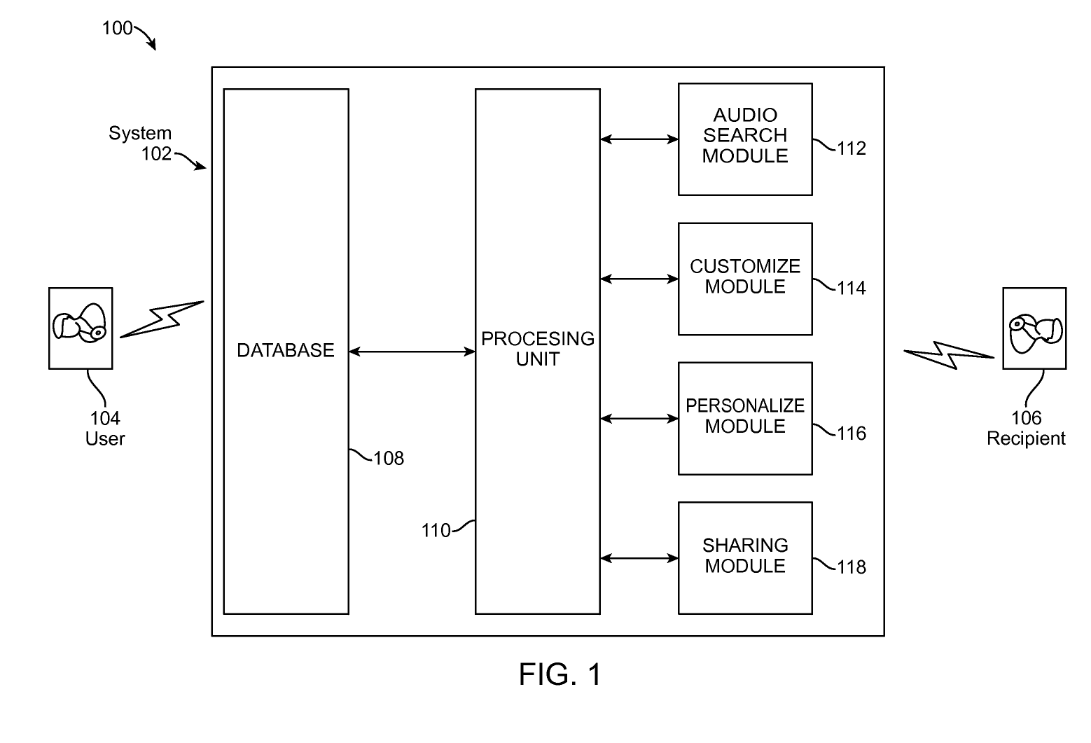

FIG. 1 illustrates a block diagram 100 of a system 102 for sharing interactive media content by at least one user 104 with at least one recipient 106 over a communication network. The system 102 is operated by a user 104 and communicates with at least one the recipient 106 through the communication network. The system 102 includes at least one database 108 for storing one or more instructions related to at least one interactive media content and at least one processing unit 110 coupled with the at least one database 108 and the communication network.

The interactive media content includes at least one audio media content and at least one visual media content. The processing unit 110 is configured to execute one or more instructions stored in at least one database 108. The processing unit 110 includes an audio search module 112, a customize module 114, a personalize module 116 and a sharing module 118.

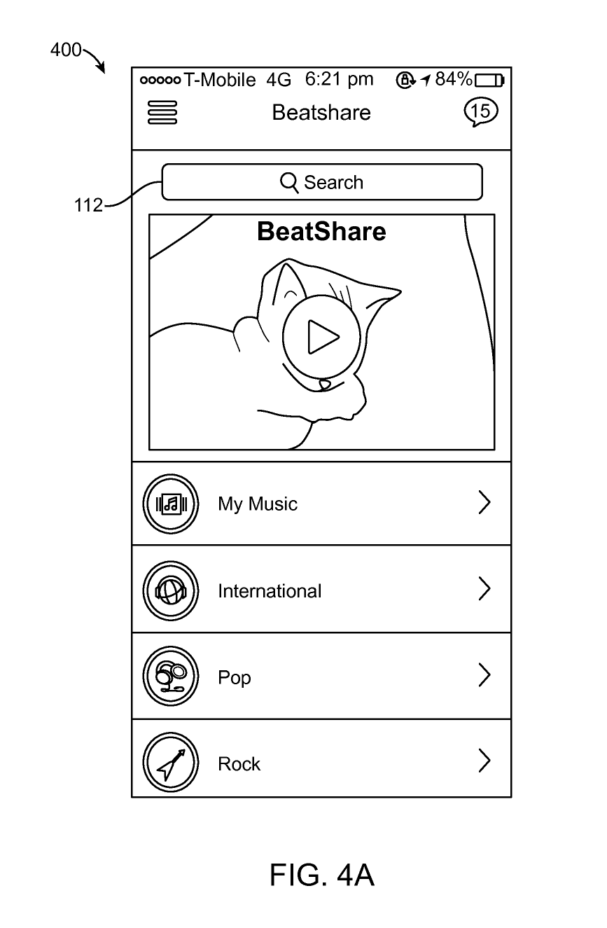

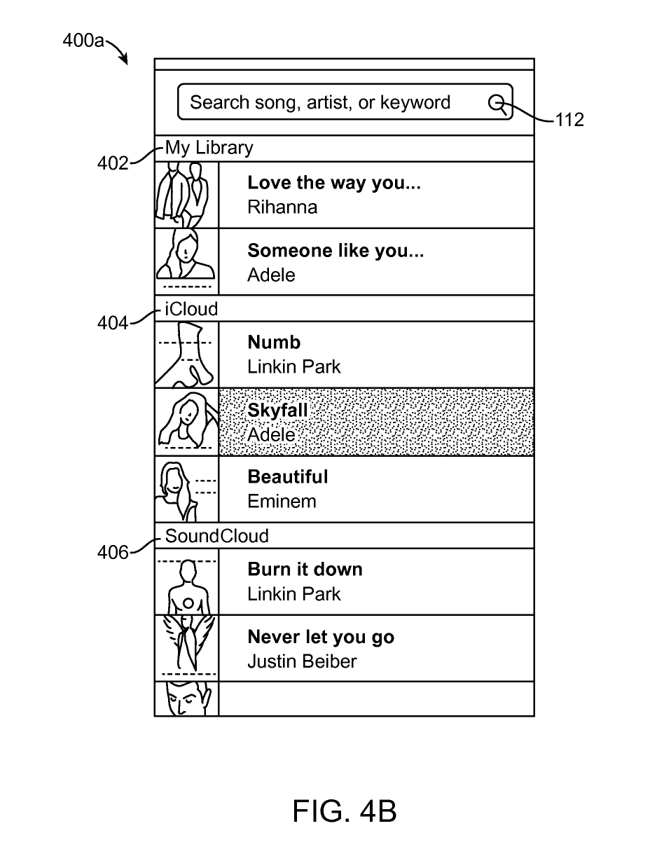

The audio search module 112 allows the user 104 to select at least one of audio media content from the database 108. Examples of the database 108 includes but not limited to a central database, a cloud database or a system library. The audio search module 112 is explained in detail in conjunction with FIG. 4A and FIG. 4B of the present invention.

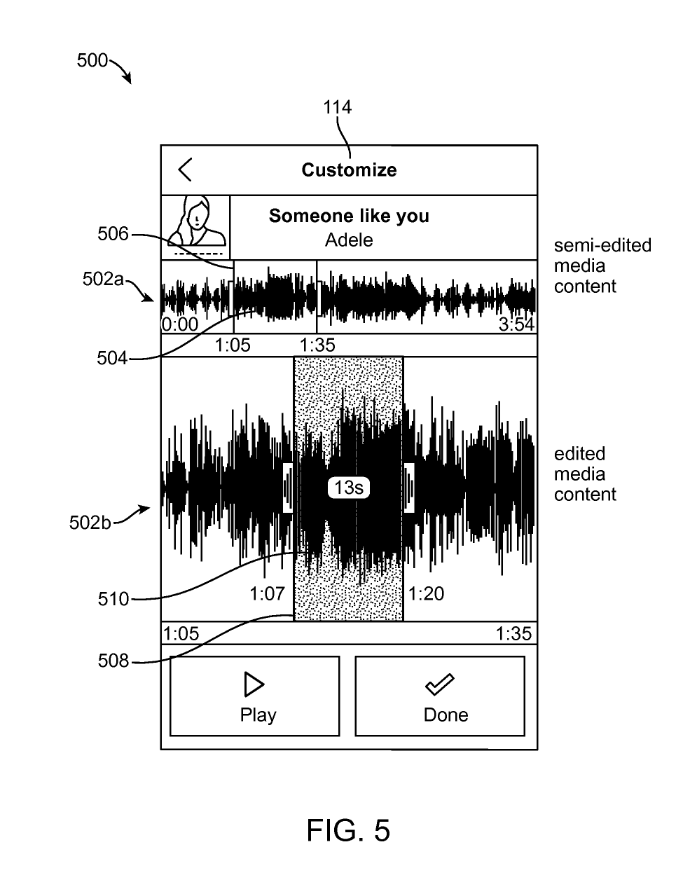

The customize module 114 performs one or more editing operations on the selected audio media content for generating an edited audio media content. Examples of one or more editing operations include but not limited to cropping of audio media content. The customize module 114 is explained in detail in conjunction with FIG. 5 of the present invention.

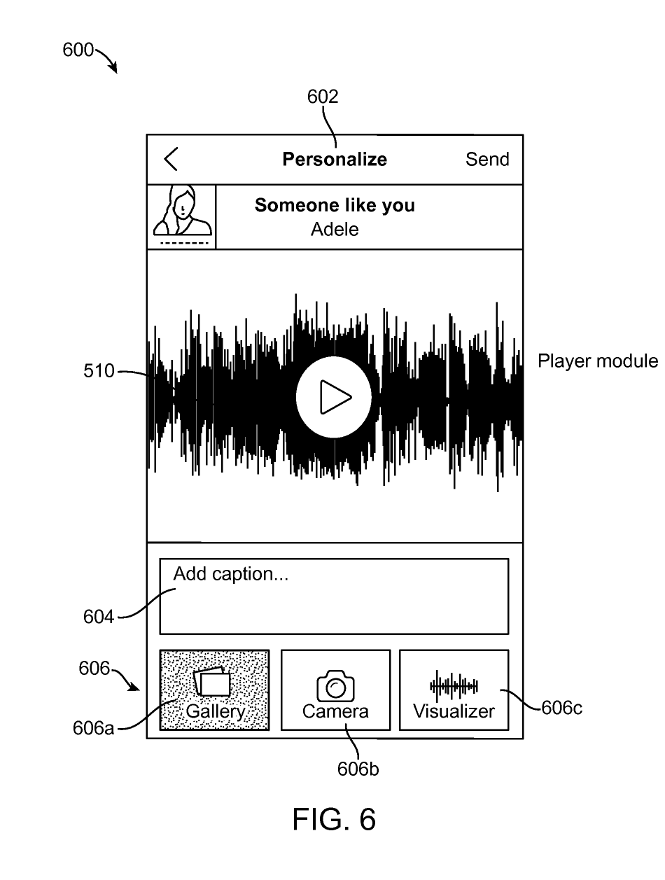

The personalize module 116 merges at least one edited audio media content with the pre-stored interactive media content for generating modified interactive media content. In a preferred embodiment of the present invention, the edited audio media content is modified with images, video or visualizer. The personalize module 116 is explained in detail in conjunction with FIG. 6 of the present invention.

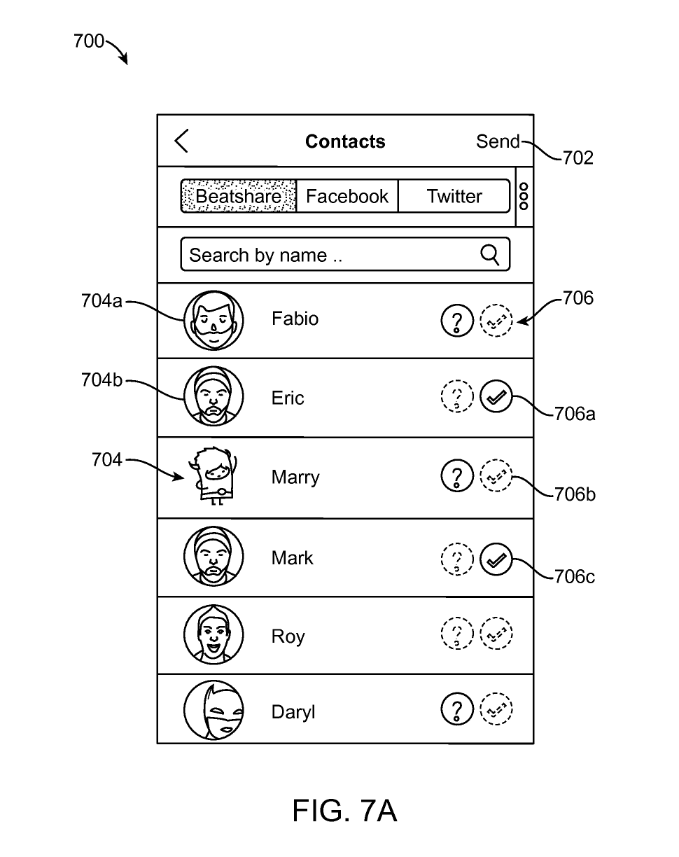

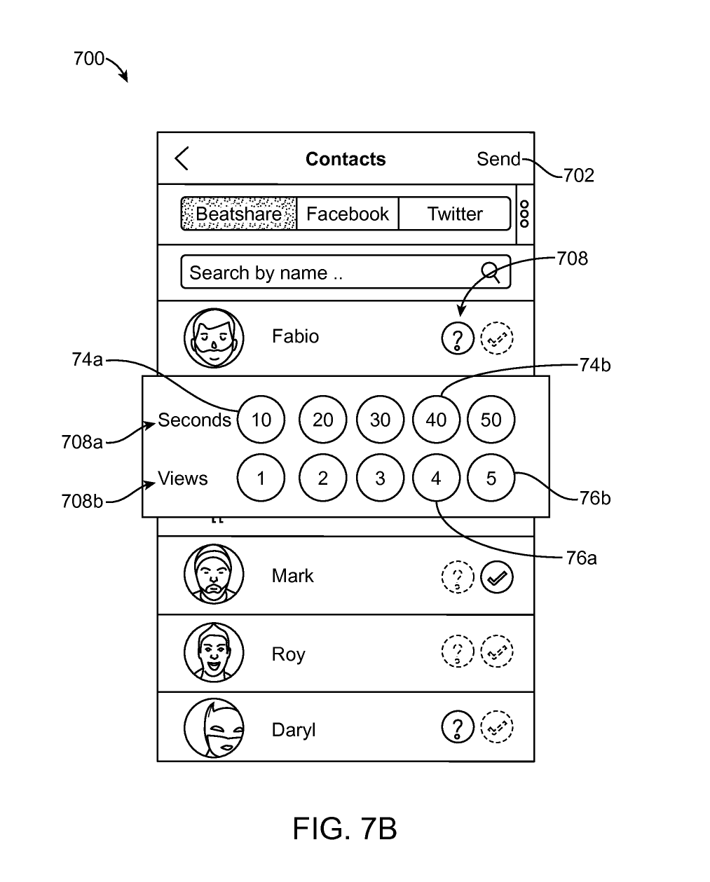

The sharing module 118 enables at least one user to share the modified interactive media content with at least one recipient over the communication network. The sharing of the modified interactive media content may be done with either within the database or over facebook, twitter etc. The sharing module 118 is explained in detail in conjunction with FIG. 7a, 7b of the present invention.

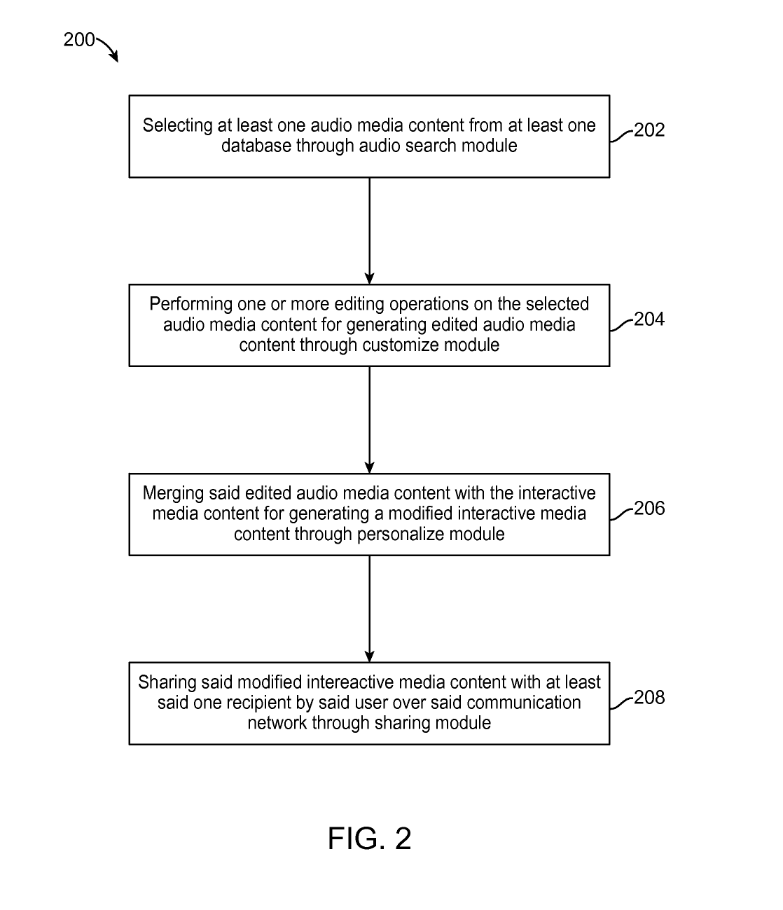

FIG. 2 illustrates a flowchart of a method 200 for sharing interactive media content by at least one user with at least one recipient over a communication network. The method 200 initiates with a step 202 of selecting at least one of the audio media content from at least one of the database through audio search module. The step 202 is explained in detail in conjunction with FIG. 4A and FIG. 4B of the present invention.

The step 202 is followed by a step 204 of performing one or more editing operations on the selected audio media content for generating edited audio media content through customize module. The step 204 is then followed by a step 206 of merging the edited audio media content with the pre-stored interactive media content for generating a modified interactive media content through personalize module. The step 204 and the step 206 are explained in detail in conjunction with FIG. 5 and FIG. 6 respectively.

The step 206 is then followed by a step 208 of sharing the modified interactive media content with at least one of the recipient by the user over the communication network through the sharing module. The step 208 is explained in detail in conjunction with FIG. 7A, 7B of the present invention.

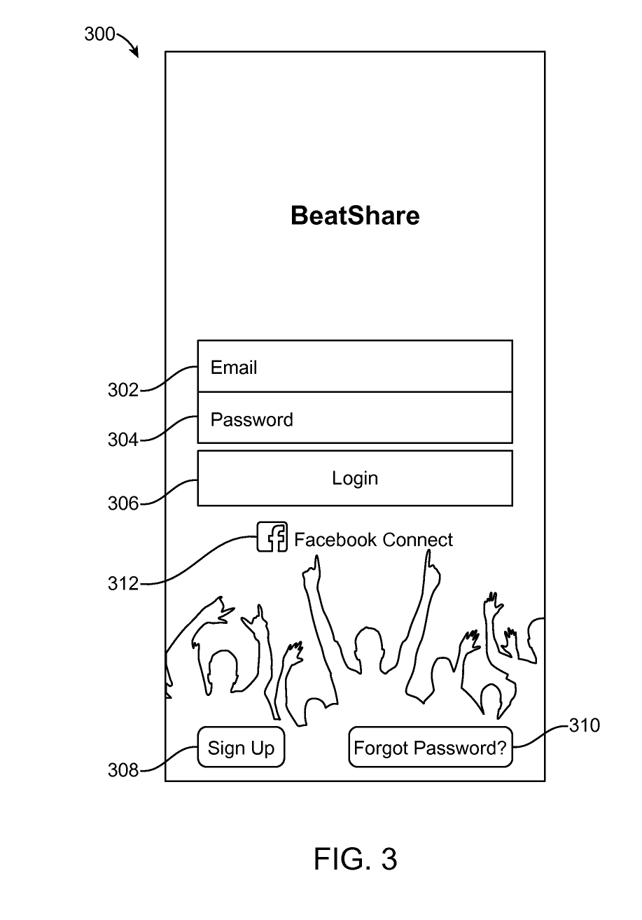

FIG. 3 illustrates a screenshot showing, by way of an example, a UI 300 for registering a user on at least one of the database in accordance with an embodiment of the present invention. The UI 300 displays an email tab 302 and a password tab 304 for allowing the user to enter the email address and password respectively for logging in the database through login tab 306.

In another embodiment of the present invention, the user may further register on the database by using sign up tab 308. Further in case of forget password, UI 300 allows the user to reset the password through the forget password tab 310. The user may further login in the database through the facebook connect tab 312.

FIG. 4A and FIG. 4B illustrates a screenshot showing, by way of an example, a UI 400 and UI 400a for showing audio search module 112 and various databases respectively, in accordance with an embodiment of the present invention. The UI 400 displays an audio search module 112 for searching audio media content from the database. The database could be either system library or a cloud server linked to the database.

FIG. 4B illustrates a UI 400a for displaying various databases for allowing the user to select audio media content. Examples of database include but not limited to my library 402, icloud 404 or soundcloud 406. My library 402 contains songs that are stored in the local database, icloud 404 contain songs stored on Apple's™ database and soundcloud 406 contain songs stored on Soundclouds™ own server. However it would be readily apparent to those skilled in the art that various other databases may also be linked to audio search module 402 for selecting a song without deviating from the scope of the present invention.

In a preferred embodiment of the present invention, the user may search on the audio search module 402 by inputting text (keywords). Further, in other embodiment of the present invention the user may search through artist name, song title, and album name etc.

FIG. 5 illustrates a screenshot showing, by way of an example, a UI 500 of customize module 114 for performing one or more editing operations on the selected audio media content in accordance with an embodiment of the present invention. In a preferred embodiment of the present invention, the customize module 114 further includes a first crop module 502a for selecting a portion of audio media content to create a semi-edited audio media content 504. In an exemplary embodiment as shown in the FIG. 5, UI 500 displays a box 506 of a window for 20 seconds which allows the user to crop 20 semi-audio media content 504.

Further, the customize module 114 includes a second crop module 502b for selecting a portion of the semi-edited audio media content 504 for creating the edited audio media content. In an exemplary embodiment as shown in FIG. 5, GUI 500 displays a window 508 for further cropping the 20 seconds semi-audio media content 504 to 13 seconds edited audio media content 510. Thus in a preferred embodiment of the present invention, the edited audio media content 510 is of 13 seconds. However, it would be readily apparent to those skilled in the art that various time intervals may also be provided for the box 506 and the window 508 for cropping the audio media content 504 without deviating from the scope of the present invention.

FIG. 6 illustrates a screenshot showing, by way of an example, UI 600 of personalize module 602 for merging edited audio media content 510 with pre-stored interactive media content in a preferred embodiment of the present invention. The personalize module 602 further includes a text module 604 for adding textual messages to the edited audio media 510 content to form a modified interactive media content. The users may give a caption as a textual message to the edited audio media content for forming a modified audio media content.

The personalize module 602 further includes a visual media creation module 606 for creating a visual media content for editing the edited audio media content 510 for generating the modified audio media content. The visual media content may be created through images or videos stored from the gallery 606a, capturing images or videos from the camera 606b or through a visualizer 606c. The camera 606b takes the images or videos to the gallery 606a and thus the media content from camera 606b is available as pre-stored interactive media content.

FIG. 7A illustrates a screenshot showing, by way of an example, UI 700 of sharing module 702 for sharing modified interactive media content in a preferred embodiment of the present invention. The user may share the modified interactive media content by selecting at least one of the recipients 704 such as Fabio 704a, Eric 704b etc. For exemplary purposes as shown in FIG. 7, the user shares the modified media content with the recipient 704a Fabio.

In another preferred embodiment of the present invention, the sharing module 702 further includes an anonymous module 706 for allowing the user to be anonymous before sharing the modified interactive media content with at least one of the recipient. For exemplary purposes as shown in FIG. 7, the user is non-anonymous for recipient 704a Fabio and is anonymous for recipient 704b Eric. As shown in UI 700, anonymous module 706 displays checkboxes such as 706a, 706b, 706c etc for each of the recipients 704. In an exemplary embodiment of the present invention, for checkbox 706a and checkbox 706c the user is anonymous for the corresponding recipient and but checkbox 706b displays the user is not anonymous for the corresponding recipient.

FIG. 7B illustrates a screenshot showing, by way of an example, UI 700b of sharing module 702 for sharing modified interactive media content in a preferred embodiment of the present invention. The sharing module 702 further includes a first self-destruct module 708a for destructing the modified interactive media content after sharing with at least one of the recipient from at least one of the database on completion of a time specified by the user.

For exemplary purposes as shown in FIG. 7B, the user selects a time of destruction of modified interactive media content from the provided options such as option 74a of 10 seconds, option 74b for 40 seconds etc. However, it would be readily apparent to those skilled in the art that various other types of time format such as minutes, hours and days may also be used without deviating from the scope of the present invention.

Further, in another embodiment of the present invention, the sharing module 702 also includes a second self-destruct module 708b to self-destruct the shared modified interactive media content from at least one of the database after a specified number of times viewed by said recipient, wherein the user defines the number of times the recipient views the shared modified interactive media content.

For exemplary purposes as shown in FIG. 7B, the user selects number of views to self-destruct the shared modified media content from at least one of the database after a specified number of times viewed by the recipient. The user defines the number of times such as 76a for five views, 76b for four views etc. However it will be readily apparent to those skilled in the art that different number of views may also be envisioned without deviating from the scope of the present invention.

Interactive media content in the present invention includes but is not limited to text, still images, animation, video, audio and any other form of interactive media. The present system and method for the process of searching, customizing, personalizing and sharing interactive media may be used with different electronic devices including but not limited to mobile phones, smartphones, tablet computers, laptops, desktop computers, ubiquitous computing devices or any other devices.

In a preferred embodiment of the present invention, the system and method for the process of searching, customizing, personalizing and sharing interactive media may be incorporated into different software formats, including but not limited to software, applications, system programs, or any other software embodiments that are used for the process of searching, customizing, personalizing and sharing interactive media. These software formats may then be used with different electronic devices including but not limited to mobile phones, smartphones, tablet computers, laptops, desktop computers, ubiquitous computing devices or any other devices which are used for the process of searching, customizing, personalizing and sharing interactive media.

The system and method for the process of searching, customizing, personalizing and sharing interactive media may be used on different operating system environments, including but not limited to IOS, windows, chrome, Linux, Ubuntu, gnome or any other operating system environments that are used for creating a system and method for the process of searching, creating, editing, merging and sharing interactive media.

The techniques described herein may be implemented by various means. For example, these techniques may be implemented in hardware, firmware, software, or a combination thereof. For a hardware implementation, the processing units at a transmitter may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. The processing units at a receiver may also be implemented within one or more ASICs, DSPs, processors, and so on.

For a software implementation, the techniques may be implemented with instructions (e.g., procedures, functions, and so on) that perform the functions described herein. The instructions may be stored in a memory and executed by the processor. The memory may be implemented within the processor or external to the processor.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The foregoing discussion discloses and describes merely exemplary embodiments of the present invention. One skilled in the art will readily recognize from such discussion and from the accompanying drawings that various changes, modifications and variations may be made therein without departing from the spirit and scope of the invention. Therefore, it is intended that the invention may not be limited to the particular embodiment disclosed, but that the invention will include all embodiments falling within the scope of the appended claims.

1. A system for sharing interactive media content by at least one user with at least one recipient over a communication network, said system comprising:
at least one database for storing one or more instructions related to at least one interactive media content, wherein said at least one interactive media comprising an audio media content and a visual media content; and
at least one processing unit coupled with at least one of said database and said communication network, said processing unit configured to execute one or more instructions stored in said at least one database comprising:
an audio search module to select at least one audio media content from at least one of said database;
a customize module to perform one or more editing operations on the selected audio media content for generating an edited audio media content;
a personalize module to merge said edited audio media content with a pre-stored interactive media content for generating a modified interactive media content; and
a sharing module to enable at least one said user to share said modified interactive media content with at least one said recipient over the communication network.

2. The customize module according to claim 1 comprising a first crop module to select a portion of said selected audio media content for creating a semi-edited audio media content.

3. The customize module according to claim 2 comprising a second crop module to select a portion of said semi-edited audio media content for creating said edited audio media content.

4. The personalize module according to claim 1 further comprising a text module to add textual messages to said edited audio media content for generating said modified audio media content.

5. The personalize module according to claim 1 further comprising a visual media creation module to create a visual media content for merging with said edited audio media content for generating said modified audio media content.

6. The visual media creation module according to claim 5 wherein said visual media content created by using camera associated with said processor.

7. The sharing module according to claim 1 further comprising an anonymous module for allowing said user to be anonymous before sharing said modified interactive media content with said at least one recipient.

8. The sharing module according to claim 1 further comprising a first self-destruct module for destructing said modified interactive media content after sharing with at least one recipient from at least one of said database on completion of a time specified by said user.

9. The sharing module according to claim 1 further comprising a second self-destruct module to self-destruct the shared modified interactive media content from at least one of said database after a specified number of times viewed by said recipient, wherein said user defines the number of times said recipient views said shared modified interactive media content.

10. The system according to claim 1 further comprising a player module to play at least one of:
said an edited audio media content;
said visual media content; and
modified interactive media content.

11. A non-transitory computer readable storage medium including instructions that, when executed by a processing unit, cause the processing unit to perform operations comprising the steps of:
selecting at least one audio media content from at least one database through audio search module;
performing one or more editing operations on the selected audio media content for generating an edited audio media content through a customize module;
merging at least one said edited audio media content with a pre-stored interactive media content for generating a modified interactive media content through a personalize module; and
sharing said modified interactive media content with at least one said recipient by at least one said user over the communication network through a sharing module.

12. The method according to claim 11 further comprising the steps of:
selecting a portion of said selected audio media content for creating said semi-edited audio media content through a first crop module; and
selecting a portion of said semi-edited audio media content for creating said edited audio media content through a second crop module.

13. The method according to claim 11 further comprising the steps of adding textual messages to said edited audio media content for generating said modified audio media content through a text module.

14. The method according to claim 11 further comprising a step of creating a visual media content for editing said edited audio media content for generating said modified media content through a visual media creation module.

15. The method according to claim 11 wherein said visual media content is created by using camera associated with the processor.

16. The method according to claim 11 further comprising a step of allowing said user to be anonymous before sharing said modified interactive media content with at least one recipient through an anonymous module.

17. The method according to claim 11 further comprising a step of destructing said modified interactive media content after sharing with at least one recipient from at least one of said database on completion of a time specified by said user through a first self-destruction module.

18. The method according to claim 11 further comprising a step of self-destructing the shared modified interactive media content from at least one of said database after a number of times viewed by said recipient specified by the user using a through a second self-destruct module.

19. The method according to claim 10 further comprising a step of playing at least one of said edited audio media content; said visual media content; and said modified interactive media content.
